(19) United States
(12) Patent Application Publication
(10) Pub. No.: US 2026/0110904 A1
(43) Pub. Date: Apr. 23, 2026

(54) DIGRESSIVE LENS FOR VIRTUAL IMAGE

(71) Applicant: Meta Platforms Technologies, LLC, Menlo Park, CA (US)

(72) Inventors: Ian Erkelens, Kirkland, WA (US); Karol Constantine Hatzilias, Sammamish, WA (US); Aaron Schmitz, Woodinville, WA (US); Michael Scott Fenton, Sunnyvale, CA (US); Garret Odom, Tucson, AZ (US); Robin Sharma, Woodinville, WA (US)

(21) Appl. No.: 18/918,524

(22) Filed: Oct. 17, 2024

(51) Int. Cl. G02B 27/01; G02C 7/06

(52) U.S. Cl. CPC G02B 27/0172; G02C 7/066; G02B 2027/0178

(57) ABSTRACT

Implementations of the disclosure include a head-mounted display (HMD) including a display and a digressive lens. The display is configured to generate display light that includes virtual images. The digressive lens is configured to provide spatially varying optical power to focus the virtual images to an eyebox region. A lower region of the digressive lens has a less positive optical power than an upper region of the digressive lens.

### TECHNICAL FIELD

This disclosure relates generally to optics, and in particular to optics for head-mounted displays (HMD).

### BACKGROUND INFORMATION

Head-mounted displays (HMDs) are worn on a head of a user and direct display light into the eye of the user. Displays configured for HMDs are sometimes referred to as near-eye displays due to their close proximity to the eye, when in use. The design of near-eye displays and associated optical systems allow the user of an HMD to focus on virtual images included in the display light directed to the eye. The weight, speed, size, and power consumption of focusing solutions are typically considered in systems that assist HMD users in focusing on virtual images.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates an example head-mounted display (HMD) including an optical element including a digressive lens having spatially varying optical power, in accordance with aspects of the disclosure.

FIG. 2 illustrates a top view of a portion of an example HMD that includes a display layer disposed between a digressive lens and an optional progressive lens, in accordance with aspects of the disclosure.

FIG. 3 illustrates an example digressive lens, in accordance with aspects of the disclosure.

FIG. 4 illustrates an example progressive lens, in accordance with aspects of the disclosure.

FIG. 5 illustrates a side view of an example digressive lens, display layer, and optional progressive lens, in accordance with aspects of the disclosure.

FIG. 6 illustrates a chart showing an example digressive design for a given optical power with respect to a gaze angle of a user, in accordance with aspects of the disclosure.

FIG. 7 illustrates virtual image distances (VIDs) with respect to gaze angles of a user, in accordance with aspects of the disclosure.

### DETAILED DESCRIPTION

Embodiments of digressive lenses for focusing virtual images are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6 μm.

In aspects of this disclosure, the term “transparent” may be defined as having greater than 90% transmission of light. In some aspects, the term “transparent” may be defined as a material having greater than 90% transmission of visible light.

Vergence-accommodation conflicts (VAC) are created when the focal distance of an image in a head-mounted display (HMD) is not the same as the stereo-rendering distance (the perceived distance of the content in space). This forces the eyes of the user to converge to a different distance from which they are focused if they want to view the rendered content clearly. In the real world, a person is rarely faced with this sort of conflicting stereo-cue. The focusing response (accommodation) and eye-alignment response (convergence) are generally very tightly linked to each other in human oculomotor systems such that if one changes, the other changes too. When the user is presented with virtual content with VAC and thus attempts to ‘decouple’ these two responses, it can increase the required focusing time of the user. Currently, most augmented reality (AR), mixed reality (MR), and virtual reality (VR) architectures use a single, fixed focal distance for image formation. This means that VAC may be created for virtual content that is rendered at a distance that is not the same as the display systems virtual image distance (VID) and thus there is a very limited range in depth from which augmented or virtual content can be rendered to the user without potentially causing VAC.

Implementations of the disclosure may mitigate VAC by designing the VID (in optical space) of HMD optics to contour to the expected geometry of the world. The power of the VID may vary based on a vertical gaze angle of a user, in some implementations. The HMD optics may be considered digressive lenses where a lower region of the digressive lens has a less positive optical power than an upper region of the digressive lens—moving the VID towards the user in the lower parts of the field of view. In contrast to the disclosed digressive lenses for head-mounted displays, progressive lenses have been widely available in prescription glasses to provide a lower region (e.g. for reading) having greater positive optical power than an upper region of the progressive lens that is configured for focusing to farther distances (e.g. driving).

In implementations of the disclosure, a lens in an HMD provides spatially varying optical power to focus virtual images for a user. The spatially varying optical power may be in the form of a digressive lens having a lower region that has a less positive optical power than an upper region of the digressive lens. The upper region of the lens may correspond to a gaze angle associated with focusing on far-field objects (e.g. 2 meters or more) and the lower region of the lens may correspond to a gaze angle associated with focusing on near-field objects (e.g. a book). An intermediate region of the lens may provide an optical power that is between the lower region and the upper region of the digressive lens to assist the user focusing on virtual images presented at an intermediate distance.

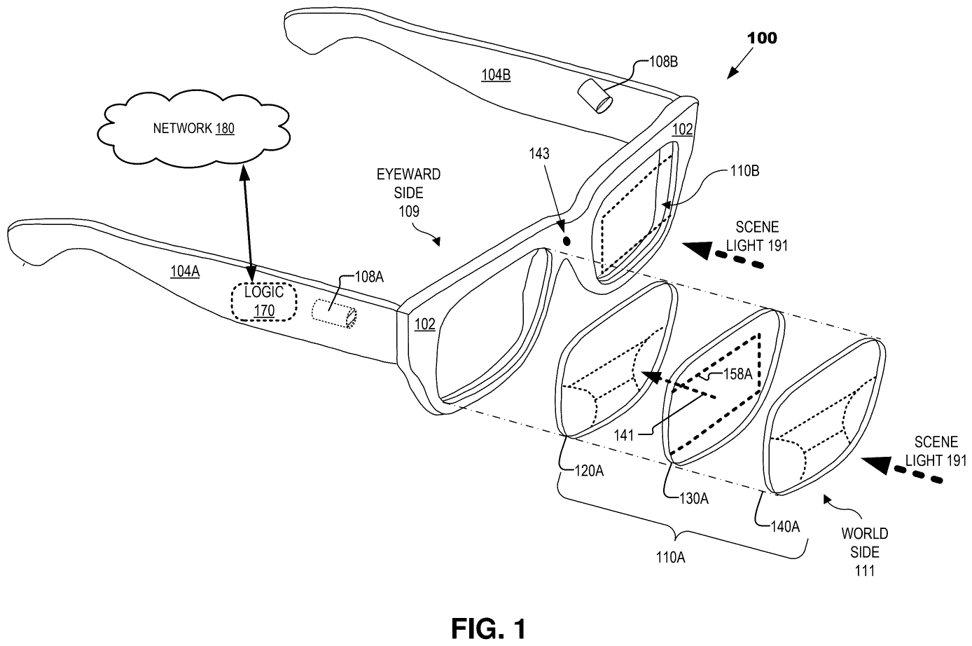

In some implementations, a progressive lens is added to HMD optics that include a digressive lens. The progressive lens may cancel out the optical power of the digressive lens so that when a user views real-world images, the affect of the digressive lens is offset by the progressive lens. A waveguide may be disposed between the progressive lens and the digressive lens so that the display light (propagating in the waveguide) only encounters the digressive lens to focus virtual images in the display light for a user of the HMD. These and other embodiments are described in more detail in connection with FIGS. 1-7.

FIG. 1 illustrates an example head-mounted display (HMD) 100 including an optical element 110A including a digressive lens 120A having spatially varying optical power, in accordance with aspects of the present disclosure. The illustrated example of HMD 100 is shown as including a frame 102, temple arms 104A and 104B, and near-eye optical elements 110A and 110B. Cameras 108A and 108B are shown as coupled to temple arms 104A and 104B, respectively. Cameras 108A and 108B may be configured to image an eyebox region to image the eye of the user to capture eye data of the user.

Cameras 108A and 108B may image the eyebox region directly or indirectly. For example, optical elements 110A and/or 110B may have an optical combiner (not specifically illustrated) that is configured to redirect light from the eyebox to the cameras 108A and/or 108B. In some implementations, near-infrared light sources (e.g. LEDs or vertical-cavity side emitting lasers) illuminate the eyebox region with near-infrared illumination light, and cameras 108A and/or 108B are configured to capture infrared images. Cameras 108A and/or 108B may include complementary metal-oxide semiconductor (CMOS) image sensors. A near-infrared filter that receives a narrow-band near-infrared wavelength may be placed over the image sensor so that the image sensor is sensitive to the narrow-band near-infrared wavelength while rejecting visible light and wavelengths outside the narrow-band. The near-infrared light sources may emit the narrow-band wavelength that is passed by the near-infrared filters.

HMD 100 includes processing logic 170. Processing logic 170 may be communicatively coupled to a network 180. Processing logic 170 may be communicatively coupled to network 180 via wired or wireless connection. Processing logic 170 may transmit and/or receive data from network 180. Network 180 may include a local device or remote computing (e.g. compute power in a data center).

As shown in FIG. 1, frame 102 is coupled to temple arms 104A and 104B for securing the HMD 100 to the head of a user. Example HMD 100 may also include supporting hardware incorporated into the frame 102 and/or temple arms 104A and 104B. The hardware of HMD 100 may include any of processing logic (e.g. processing logic 170), wired and/or wireless data interface for sending and receiving data, graphic processors, and one or more memories for storing data and computer-executable instructions. In one example, HMD 100 may be configured to receive wired power and/or may be configured to be powered by one or more batteries. In addition, HMD 100 may be configured to receive wired and/or wireless data including video data.

FIG. 1 also illustrates an exploded view of an example of near-eye optical element 110A. Near-eye optical element 110B may be configured similarly to near-eye optical element 110A. Near-eye optical element 110A is shown as including a digressive lens 120A, a display layer 130A, and a progressive lens 140A. Progressive lens 140A is illustrated as being disposed on a world side 111 of near-eye optical element 110A. Components 120A, 130A, and 140A may be coupled together by a lamination process. In some implementations, air gaps may separate components 120A, 130A, and 140A. Display layer 130A may include a waveguide 158A that is configured to direct virtual images included in visible display light 141 to an eye of a user of HMD 100. In some implementations, at least a portion of the electronic display of display layer 130A is included in frame 102 of HMD 100. The electronic display may include an LCD, an organic light emitting diode (OLED) display, micro-LED display, pico-projector, or liquid crystal on silicon (LCOS) display for generating the display light 141.

FIG. 1 illustrates near-eye optical elements 110A and 110B that are configured to be mounted to the frame 102. In some examples, near-eye optical elements 110A and 110B may appear transparent or semi-transparent to the user to facilitate augmented reality such that the user can view visible scene light 191 from the surrounding environment while also receiving display light 141 directed to their eye by way of display layer 130A.

Digressive lens 120A is shown as being disposed between display layer 130A and the eyeward side 109 of the near-eye optical element 110A. Digressive lens 120A is at least partially transparent to visible light, such as scene light 191 received from the external environment and/or display light 141 received from the display layer 130A. Digressive lens 120A may be formed from a refractive material. In some aspects, digressive lens 120A has a thickness and/or curvature that corresponds to the specifications of a user. In other words, digressive lens 120A may be a prescription lens blended with a digressive lens, as will be described in more detail. However, in other examples, digressive lens 120A may be a non-prescription lens.

Those skilled in the art understand that near-eye optical element 110A may include different arrangements of the layers (e.g. layers 120A, 130A, and/or 140A) additions of layers including intervening layers, or even deletion of some layers. Additional electrical components (e.g. light sources or sensors) may be included in optical element 110A, in some implementations. In an implementation, an eye-tracking layer may be added to near-eye optical element 110A.

While FIG. 1 illustrates an HMD 100 configured for augmented reality (AR), the disclosed implementations may also be used in other implementations of a head mounted display such as in a mixed reality (MR) context of a head-mounted display where images from the real-world scene are passed through to a display of the HMD.

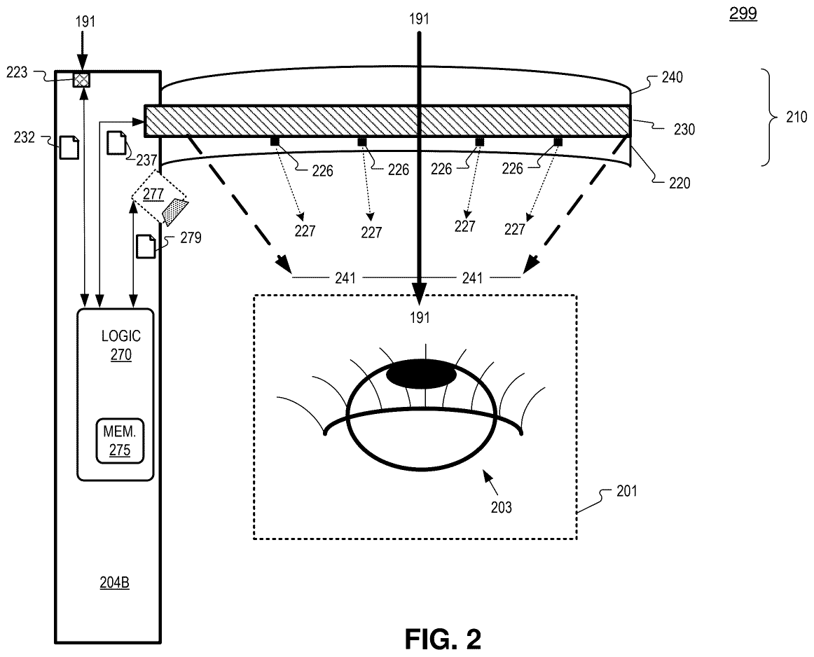

FIG. 2 illustrates a top view of a portion of an example HMD 299 that includes a display layer 230 disposed between a digressive lens 220 and an optional progressive lens 240, in accordance with implementations of the disclosure. The optional progressive lens 240 may be particularly advantageous in AR contexts where real-world scene light 191 is viewed by eye 203. Including a progressive lens 240 in an MR headset may be less advantageous since real-world scene light is not incident on eye 203. Rather, a display in the MR headset generates images of the real-world in a “pass through” mode of the MR headset that passes through images of the real-world captured by a camera. HMD 299 may have some similar features as HMD 100 of FIG. 1, with further details now being provided for at least some of the same or similar elements as HMD 100. HMD 299 includes a temple arm 204B that may include processing logic 270 and a memory 275.

HMD 299 may include an optical element 210 that includes progressive lens 240, display layer 230, and digressive lens 220. Progressive lens 240 may be used for progressive lens 140A, display layer 230 may be included in display layer 130A, and digressive lens 220 may be used as digressive lens 120A, for example. Additional optical layers (not specifically illustrated) may also be included in example optical element 210.

Display layer 230 presents virtual images in display light 241 to an eyebox region 201 for viewing by an eye 203. Processing logic 270 is configured to drive virtual images 237 onto display layer 230 to present display light 241 to eyebox region 201. In some implementations, processing logic 270 pre-conditions virtual images 237 to account for the curvature of digressive lens 220. Pre-conditioning virtual images 237 may include applying particular distortion filters that are associated with digressive lens 220. All or a portion of display layer 230 may be transparent or semi-transparent to allow scene light 191 from an external environment to become incident on eye 203 so that a user can view their external environment in addition to viewing virtual images presented in display light 241. Display layer 230 may include a waveguide configured to direct display light 241 to eyebox region 201.

In the example of FIG. 2, digressive lens 220 includes light sources 226 configured to illuminate an eyebox region 201 with infrared illumination light 227. In other implementations, light sources 226 may be included in an additional layer that is laminated to digressive lens 220. Digressive lens 220 may include a transparent refractive material that functions as a substrate for light sources 226. Infrared illumination light 227 may be near-infrared illumination light.

In FIG. 2, camera 277 is configured to image (directly) eye 203. In other implementations, camera 277 may (indirectly) image eye 203 by receiving reflected infrared illumination light from an optical combiner layer (not illustrated) included in optical element 210. The optical combiner layer may be configured to receive reflected infrared illumination light (the infrared illumination light 227 reflected from eyebox region 201) and redirect the reflected infrared illumination light to camera 277. In this implementation, camera 277 would be oriented to receive the reflected infrared illumination light from the optical combiner layer of optical element 210.

Camera 277 may include a complementary metal-oxide semiconductor (CMOS) image sensor, in some implementations. An infrared filter that receives a narrow-band infrared wavelength may be placed over the image sensor so that it is sensitive to the narrow-band infrared wavelength while rejecting visible light and wavelengths outside the narrow-band. Infrared light sources (e.g. light sources 226) such as infrared LEDs or infrared VCSELS that emit the narrow-band wavelength may be oriented to illuminate eye 203 with the narrow-band infrared wavelength. Camera 277 may capture eye-tracking images 279 of eyebox region 201. Eyebox region 201 may include eye 203 as well as surrounding features in an ocular area such as eyebrows, eyelids, eye lines, etc. Processing logic 270 may initiate one or more image captures with camera 277 and camera 277 may provide eye-tracking images 279 to processing logic 270.

In the illustrated implementation of FIG. 2, a memory 275 is included in processing logic 270. In other implementations, memory 275 may be external to processing logic 270. In some implementations, memory 275 is located remotely from processing logic 270. In implementations, virtual image(s) 237 are provided to processing logic 270 for presentation in display light 241. In some implementations, virtual images are stored in memory 275. Processing logic 270 may be configured to receive virtual images from a local memory or the virtual images may be wirelessly transmitted to the HMD 299 and received by a wireless interface (not illustrated) of the head mounted device.

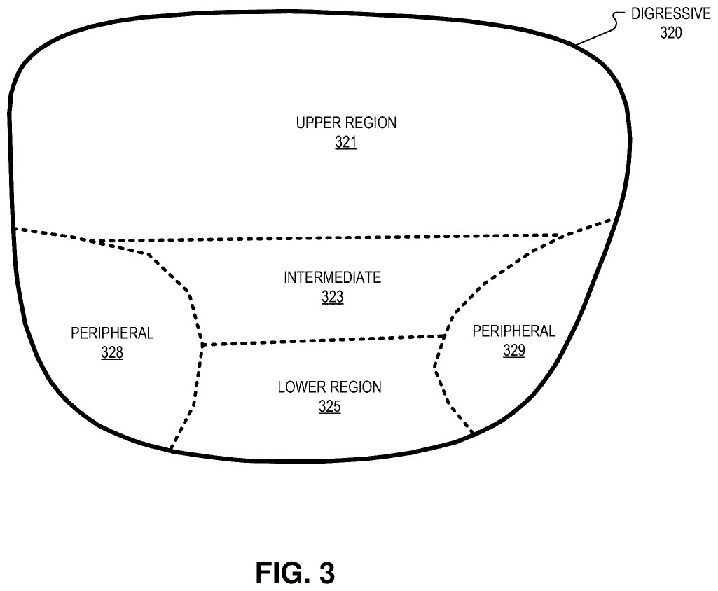

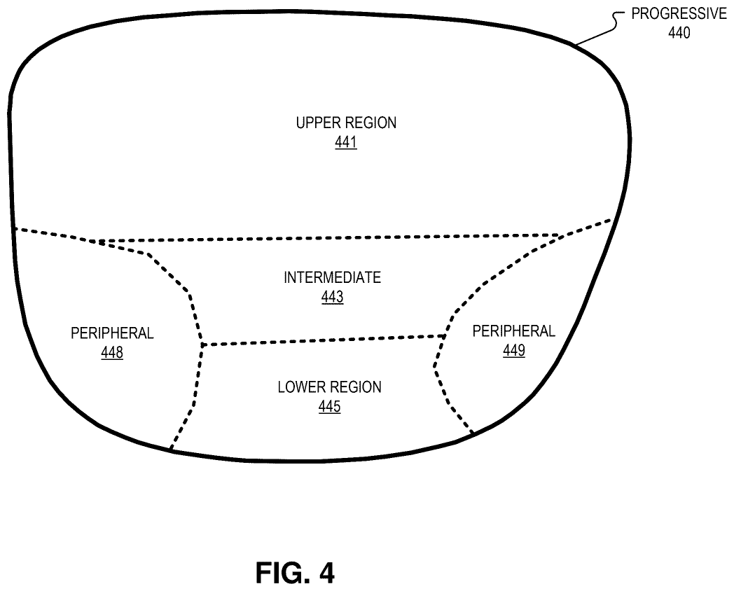

FIG. 3 illustrates an example digressive lens 320, in accordance with aspects of the disclosure. Example digressive lens 320 may be used as component 120A or 220 in FIGS. 1 and 2, respectively. Digressive lens 320 may be formed from a refractive material such as a plastic and/or glass substrate. Digressive lens 320 may be diamond-turned or injection molded to form a digressive curvature having spatially varying optical power. Digressive lens 320 is configured to provide spatially varying optical power to focus the virtual images to an eyebox region. Example digressive lens 320 includes an upper region 321 and a lower region 325. Example digressive lens 320 also includes an optional intermediate region 323. Peripheral regions 328 and 329 may have an optical power that facilitates a soft blur effect. The size and position of regions 321, 323, 325, 328, and 329 may be co-designed with regions 421, 423, 425, 428, and 429 in the progressive lens 440 of FIG. 4. The expected pupil position for each user may also change the size and position of regions 321, 323, 325, 328, and 329. The optical power of digressive lens 320 may gradually decrease (becoming less positive) in a direction from top (e.g. upper region 321) to bottom (e.g. lower region 325). In some implementations, the optical power of digressive lens 320 gradually decreases corresponding to a decreasing vertical gaze angle of a user.

Lower region 325 of digressive lens 320 is associated with a lower gaze angle of a user of an HMD for viewing near-field portions of virtual images and the upper region 321 of digressive lens 320 is associated with a higher gaze angle of the user of the HMD for viewing far-field portions of the virtual images. Lower region 325 of digressive lens 320 has a less positive optical power than upper region 321. In some implementations, lower region 325 is in a nose-ward region of digressive lens 320.

In some implementations, an optical power difference between lower region 325 of digressive lens 320 and the upper region 321 of digressive lens 320 is five diopters or less. In some implementations, an optical power difference between lower region 325 of digressive lens 320 and the upper region 321 of digressive lens 320 is less than two diopters. In some implementations, an optical power difference between lower region 325 of digressive lens 320 and the upper region 321 of digressive lens 320 is less than 1.5 diopters.

In some implementations, upper region 321 corresponds to a gaze angle of between approximately 15 degrees and −10 degrees and the optical power for upper region 321 is between −0.5 diopters and −1 diopters. In some implementations, intermediate region 323 corresponds to a gaze angle of between approximately −10 degrees and −20 degrees and the optical power for intermediate region 323 is between −1 diopters and −1.75 diopters. In some implementations, lower region 325 corresponds to a gaze angle of between approximately −20 degrees and −30 degrees and the optical for lower region 323 is between −1.5 diopters and −2 diopters.

FIG. 4 illustrates an example progressive lens 440, in accordance with aspects of the disclosure. Example progressive lens 440 may be optionally used as component 140A or 240 in FIGS. 1 and 2, respectively. Progressive lens 440 may be formed from a refractive material such as a plastic and/or glass substrate. Progressive lens 440 may be diamond-turned or injection molded to form a progressive curvature having spatially varying optical power. Progressive lens 440 is configured to provide spatially varying optical power. Example progressive lens 440 includes an upper region 441 and a lower region 445. Example progressive lens 440 also includes an optional intermediate region 443. Peripheral regions 448 and 449 may have an optical power that facilitates a soft blur effect. The optical power of progressive lens 440 may gradually increase in a direction from top (e.g. upper region 441) to bottom (e.g. lower region 445). In some implementations, the optical power of progressive lens 440 gradually increases corresponding to a decreasing vertical gaze angle of a user.

The optical power of each region in progressive lens 440 may be cancelled out by the regions in digressive lens 320 in implementations that include a progressive lens. For example, the optical power of upper region 441 may be cancelled out by upper region 321 of digressive lens 320. Additionally, the optical power of lower region 445 may be cancelled out by lower region 325 of digressive lens 320.

Lower region 445 of progressive lens 440 is associated with a lower gaze angle of a user of an HMD and the upper region 441 of progressive lens 440 is associated with a higher gaze angle of the user of the HMD. Upper region 441 of progressive lens 440 has a less positive optical power than lower region 445. The alignment and/or offsets between progressive lens 440 and digressive lens 320 may depend on a thickness of optical components disposed between progressive lens 440 and digressive lens 320. For example, the depth of display layer 230 may affect the alignments and/or offsets between progressive lens 440 and digressive lens 320.

The combination of optical power in progressive lens 440 and digressive lens 320 focuses real-world objects to eyebox region 201. Referring briefly to FIG. 2, scene light 191 from the external environment encounters both a progressive lens 240 and a digressive lens 220 as scene light 191 propagates along an optical path to eyebox region 201. In contrast, display light 241 only encounters digressive lens 220 as it propagates along an optical path to eyebox region 201.

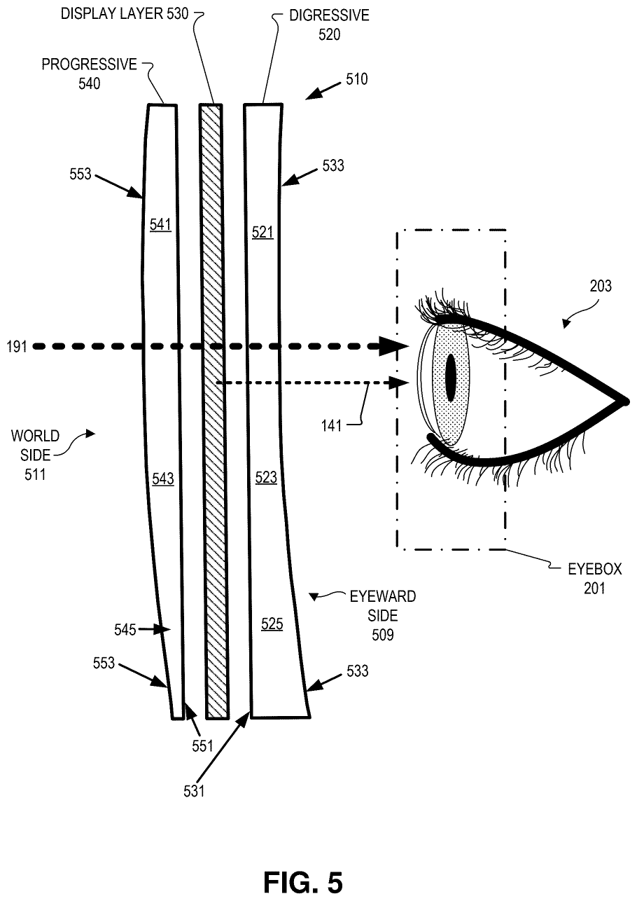

FIG. 5 illustrates a side view of an example digressive lens 520, display layer 530, and optional progressive lens 540, in accordance with aspects of the disclosure. Digressive lens 520, display layer 530, and optional progressive lens 540 may be included in near-eye optical element 510. Display layer 530 may include a waveguide configured to direct display light 141 to an eye 203 of a user occupying an eyebox region of an HMD. In the illustration of FIG. 5, digressive lens 520 includes a digressive lens curvature 533 on an eyeward side 509 of near-eye optical element 510. Eyeward side 509 is opposite world side 511 of near-eye optical element 510. Digressive lens curvature 533 is configured to provide spatially varying optical power.

In digressive lens 520, digressive lens curvature 533 may be opposite a planar side 531 of digressive lens 520. Planar side 531 of digressive lens 520 may be laminated to another optical component in near-eye optical element 510. Planar side 531 of digressive lens 520 may be laminated to display layer 530, for example. In some implementations, planar side 531 is instead replaced with a meniscus or aspheric design.

Progressive lens curvature 553 may be opposite a planar side 551 of progressive lens 540. Planar side 551 of progressive lens 540 may be laminated to another optical component in near-eye optical element 510. Planar side 551 of progressive lens 540 may be laminated to display layer 530, for example. In some implementations, planar side 551 is instead replaced with a meniscus or aspheric design.

The side view of near-eye optical element 510 includes a vertical side view of digressive lens 520. An upper region 521 is shown at the top of digressive lens 520 and a lower region 525 is shown at the bottom of digressive lens 520. An intermediate region 523 is illustrated between region 521 and 525 in digressive lens 520. Regions 521, 523, and 525 may include the features (e.g. optical power) of regions 321, 323, and 325, respectively.

The side view of near-eye optical element 510 includes a vertical side view of optional progressive lens 540. An upper region 541 is shown at the top of progressive lens 540 and a lower region 545 is shown at the bottom of progressive lens 540. An intermediate region 543 is illustrated between region 541 and 545 in progressive lens 540. Regions 541, 543, and 545 may include the features (e.g. optical power) of regions 421, 423, and 425, respectively.

When near-eye optical element 510 includes progressive lens 540, scene light 191 propagates through progressive lens 540, display layer 530, and digressive lens 520 before encountering eyebox region 201. In implementations where near-eye optical element 510 does not include progressive lens 540, scene light 191 propagates through display layer 530 and digressive lens 520.

In the illustration of FIG. 5, progressive lens 540 cancels out the optical power of digressive lens 520 so that near-eye optical element 510 imparts no optical power (or approaching zero optical power) to scene light 191 propagating through near-eye optical element 510.

In some implementations, an optical prescription is incorporated into near-eye optical element 510. The optical prescription may correct for myopic, hyperopic, and/or presbyopic vision. The optical prescription may be a cylindrical prescription to correct for astigmatism. For contexts where near-eye optical element 510 corrects presbyopic vision, the correction would be included in the lens on the world side 511. In some implementations, the digressive lens curvature 533 includes a prescription curvature to correct myopia, hyperopia, or astigmatism.

In an implementation of the disclosure, an initial digressive lens power has spatially varying optical power between −0.5 diopters and −2.0 diopters. If a user has a myopic prescription of −3.0 diopters, the digressive lens 520 may have spatially varying optical power of −3.5 diopters to −5.0 diopters since the myopic prescription is added to the initial digressive lens power. If an optional progressive lens (e.g. progressive lens 540) is included in a near-eye optical element (e.g. element 510), the spatially varying optical power of the progressive lens may be configured to cancel out the spatially vary optical power of the initial digressive lens power (−0.5 to −2.0 diopters) but not cancel out the myopic prescription included in the digressive lens 520.

In another example, a user may have a hyperopic prescription of 1.0 diopters. If the initial digressive lens power has spatially varying optical power between −0.5 diopters and −2.0 diopters, the digressive lens 520 may have spatially varying optical power of +0.5 diopters to −1.0 diopters since the hyperopic prescription is added to the initial digressive lens power. If an optional progressive lens (e.g. progressive lens 540) is included in a near-eye optical element (e.g. element 510), the spatially varying optical power of the digressive lens may be configured to cancel out the spatially vary optical power of the initial digressive lens power (−0.5 to −2.0 diopters) but not cancel out the hyperopic prescription included in the digressive lens 520.

Similar to the examples provided for hyperopic and myopic prescriptions, a prescription to correct for astigmatism may be added to an initial digressive lens power and an optional progressive lens may cancel out the optical power of the digressive lens but not the prescription to correct for astigmatism.

In an implementation of the disclosure where near-eye optical element 510 is configured to correct presbyopia, progressive lens 540 includes a presbyopic prescription and digressive lens 520 includes almost zero optical power. In general, persons with presbyopia have less Vergence-accommodation conflicts (VAC), which may decrease the need to provide substantial optical power with digressive lens 520. Although, there may be a need for increased progressive power for correction of real-world scene light 191.

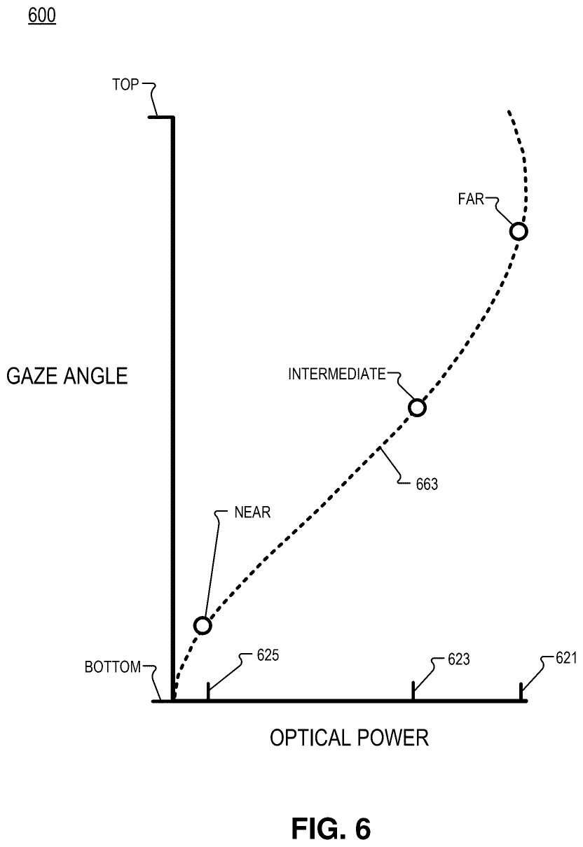

FIG. 6 illustrates a chart 600 showing an example digressive design for a given optical power with respect to a gaze angle of a user, in accordance with aspects of the disclosure. In chart 600, the y-axis is a gaze angle of the user and the x-axis is optical power. Line 663 illustrates an example curve for a digressive lens where the optical power of the digressive lens gradually decreases as a vertical gaze angle of a user decreases. Optical power 625 is roughly correlated with a gaze angle of a user for viewing near objects through a lower region (e.g. lower region 325) of a digressive lens. Optical power 623 is roughly correlated with a gaze angle of a user for viewing intermediate objects through an intermediate region (e.g. intermediate region 323) of a digressive lens. And, optical power 621 is roughly correlated with a gaze angle of a user for viewing far objects through an upper region (e.g. upper region 321) of a digressive lens.

The difference between optical power 621 and 625 may be approximately 0.75 diopters, in some implementations. The difference between optical power 621 and 625 may be approximately 1.00 diopters, in some implementations. The difference between optical power 621 and 625 may be approximately 1.25 diopters, in some implementations. The difference between optical power 621 and 625 may be approximately 1.5 diopters, in some implementations. The difference between optical power 621 and 625 may be approximately 1.75 diopters, in some implementations. The difference between optical power 621 and 625 may be approximately 2.00 diopters, in some implementations.

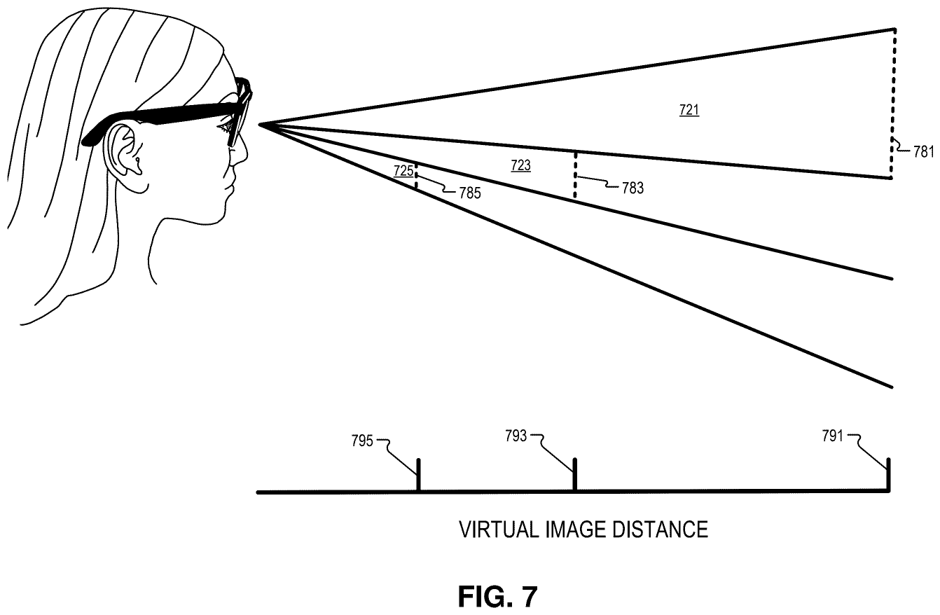

FIG. 7 illustrates virtual image distances (VIDs) with respect to gaze angles of a user, in accordance with aspects of the disclosure. FIG. 7 illustrates that a user may view a virtual object 781 in a virtual image at a VID corresponding to “far” distance 791. To view the virtual object 781 at far distance 791, the user may have a gaze angle between approximately 15 degrees and −15 degrees, where 0 degrees corresponds to a horizontal gaze angle. These gaze angles may correspond with the user viewing the virtual object 781 through an upper region 721 of a digressive lens. The upper region 721 may have the characteristics described with respect to upper region 321 of digressive lens 320, for example.

FIG. 7 also illustrates that a user may view a virtual object 783 in a virtual image at a VID corresponding to “intermediate” distance 793. To view the virtual object 783 at intermediate distance 793, the user may have a gaze angle between approximately 0 degrees and −25 degrees, as an example. This gaze angle may correspond with the user viewing the virtual object 783 through an intermediate region 723 of a digressive lens. The intermediate region 723 may have the characteristics described with respect to intermediate region 323 of digressive lens 320, for example.

FIG. 7 further illustrates that a user may view a virtual object 785 in a virtual image at a VID corresponding to “near” distance 795. To view the virtual object 785 at near distance 795, the user may have a gaze angle between approximately −20 degrees and −40 degrees, as an example. This gaze angle may correspond with the user viewing the virtual object 785 through lower region 725 of a digressive lens. The lower region 725 may have the characteristics described with respect to lower region 325 of digressive lens 320, for example.

The gaze angles corresponding to intermediate region 723 are between the gaze angles corresponding to upper region 721 and lower region 725. The difference between distance 795 and distance 791 may be approximately 1.5 meters.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. logic 170 or 270) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” (e.g. memory 275) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A head-mounted display (HMD) comprising:
a display configured to generate display light that includes virtual images; and
a digressive lens configured to provide spatially varying optical power to focus the virtual images to an eyebox region, wherein a lower region of the digressive lens has a less positive optical power than an upper region of the digressive lens.

2. The HMD of claim 1 further comprising:
a progressive lens configured to cancel out the digressive lens for scene light that would encounter the progressive lens and then the digressive lens.

3. The HMD of claim 2 further comprising:
a waveguide configured to direct the display light to the eyebox region, wherein the waveguide is disposed between the digressive lens and the progressive lens.

4. The HMD of claim 1, wherein an optical power difference between the lower region of the digressive lens and the upper region of the digressive lens is less than 1.5 diopters.

5. The HMD of claim 1, wherein the lower region of the digressive lens is associated with a lower gaze angle of a user of the HMD for viewing near-field regions of the virtual images, and wherein the upper region of the digressive lens is associated with a higher gaze angle of the user of the HMD for viewing far-field regions of the virtual images.

6. A display system comprising:
a display configured to generate display light; and
a digressive lens configured to provide spatially varying optical power to focus the display light to an eyebox region.

7. The display system of claim 6, wherein a lower region of the digressive lens has a less positive optical power than an upper region of the digressive lens.

8. The display system of claim 7 further comprising:
a progressive lens configured to cancel out the digressive lens for scene light that would encounter the progressive lens and then the digressive lens.

9. The display system of claim 8 further comprising:
a waveguide configured to direct the display light to the eyebox region, wherein the waveguide is disposed between the digressive lens and the progressive lens.

10. The display system of claim 8, wherein optical power of the digressive lens is generated from an eyeward surface of the digressive lens, and wherein progressive optical power of the progressive lens is generated from a world-side surface of the progressive lens.

11. The display system of claim 7, wherein an optical power difference between the lower region of the digressive lens and the upper region of the digressive lens is 5 diopters or less.

12. The display system of claim 11, wherein there is a gradual change in optical power from the lower region to the upper region.

13. The display system of claim 7, wherein the lower region is in a nose-ward region of the digressive lens that is beneath the upper region of the digressive lens.

14. A lens assembly comprising:
a digressive lens curvature configured to provide spatially varying optical power; and
a world-side progressive lens curvature disposed on an eyeward side of the lens assembly opposite a world-side of the lens assembly.

15. The lens assembly of claim 14 further comprising:
a waveguide disposed between the digressive lens curvature and the world-side progressive lens curvature, wherein the digressive lens curvature is configured to focus virtual images in display light to an eyebox region.

16. The lens assembly of claim 15, wherein the digressive lens curvature is formed on a digressive lens element having a planar side opposite the digressive lens curvature, and wherein the planar side is coupled to the waveguide.

17. The lens assembly of claim 14, wherein the digressive lens curvature is configured to cancel out the digressive lens curvature.

18. The lens assembly of claim 14, wherein the digressive lens curvature includes a prescription curvature to correct myopia, hyperopia, or astigmatism.

19. The lens assembly of claim 14, wherein a lower region of the digressive lens curvature has a less positive optical power than an upper region of the digressive lens curvature.

20. The lens assembly of claim 19, wherein an optical power difference between the lower region of the digressive lens curvature and the upper region of the digressive lens curvature is less than two diopters.
